(19) United States
(12) Patent Application Publication
(10) Pub. No.: US 2013/0322658 A1
(43) Pub. Date: Dec. 5, 2013

(54) DRIVER VOICE SOUND RECEIVING DEVICE

(71) Applicant: HYUNDAI MOTOR COMPANY, Seoul (KR)

(72) Inventor: Yong Joon Lee, Incheon (KR)

(73) Assignee: HYUNDAI MOTOR COMPANY, Seoul (KR)

(21) Appl. No.: 13/716,965

(22) Filed: Dec. 17, 2012

(30) Foreign Application Priority Data
Jun. 4, 2012 (KR) 10-2012-0059596

(51) Int. Cl. H04R 1/34

(52) U.S. Cl. CPC H04R 1/342
USPC 381/122

(57) ABSTRACT

Disclosed is a driver voice sound receiving device that includes a cluster lens having a transparent radial curved panel for protecting a cluster dashboard in front of a driver's seat. More specifically, the cluster lens reflects sound waves from the driver's voice and collects the reflected voice sound waves at a specific location. Additionally, a microphone is provided at a location that is adjacent to specific location where the voice sound waves reflected by the cluster lens are collected.

### CROSS-REFERENCE TO RELATED APPLICATION

This application claims under 35 U.S.C. §119(a) the benefit of Korean Patent Application No. 10-2012-0059596 filed on Jun. 04, 2012, the entire contents of which are incorporated herein by reference.

### BACKGROUND

(a) Technical Field

The present disclosure relates to a driver voice sound receiving device configured to recognize at a high degree of accuracy a driver's voice sound in a vehicle.

(b) Background Art

Recently, various telecommunication technologies have been developed and proposed in order to provide more and more driver conveniences. Hands-free technologies are one of these conveniences which have become quite popular in recent years especially due to not laws requiring their use in vehicles in order to talk on the phone. These hands-free technologies typically utilize a microphone which is generally mounted on a front roof panel of vehicle's interior in order to record a driver's or passenger's voice.

As noted above, the microphones in vehicles are conventionally disposed above the driver's voice projection since they are mounted on the roof of the vehicle. As a result the sound waves from the driver's voice are often not received well by the microphone. This is due to the fact that a driver is often staring ahead to keep his/her eyes on the road. As a result, a party on the other end of the line (e.g., during a phone call) or a voice recognition system may have difficulty understanding the driver in particular. This may make it very difficult for the driver to hold a conversation with another party or perform hand's free voice control due to poor sound quality recorded by the microphone.

To expand even further, if a voice recognition system does not receive accurate recordings of the driver's voice a driver may not be able control for example, a navigation system, vehicle start systems or any other electronic devices which are adaptable to be controlled by a voice recognition system.

Accordingly, there is a need for a technology which satisfies these consumer demands and aides in the development and expansion of voice recognition technology by increasing a driver voice sound recognizing rate to achieve better sound quality when using hands free technologies.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above-described problems associated with related art and it is an object of the present invention to provide a driver voice sound receiving device that is configured to provide a high degree of accuracy in receiving sound waves generated by the driver's voice by increasing a voice sound recognizing rate.

In order to achieve the object of the present invention, the present invention provides a driver voice sound receiving device that includes a cluster lens having a transparent radial curved panel that is configured to protect a cluster dashboard in front of a driver's seat and configured to reflect sound waves from the driver's voice and collect the reflected voice sound waves at a specific location. Additionally, a microphone is provided adjacent to the specific location where the voice sound waves reflected by the cluster lens are collected.

The cluster lens may be shaped as a dish type antenna in which the cluster lens is curved concavely toward the cluster dashboard so that the driver's sound waves are reflected to front and lower side of the cluster lens to be collected.

The microphone may be provided on an upper face of a steering wheel column facing the front surface of the cluster lens. Alternatively, the microphone may be disposed on a cluster base panel on which the cluster dash board that is provided on a lower side of the cluster lens is arranged.

The microphone may also be the same color as the cluster base panel so that the microphone is not easily recognizable by the driver.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating a driver voice sound receiving device according to an exemplary embodiment of the present invention; and

FIG. 2 is a view illustrating exemplary sound waves from a driver's voice sound collected at a specific location by the driver voice sound receiving device as shown in FIG. 1.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

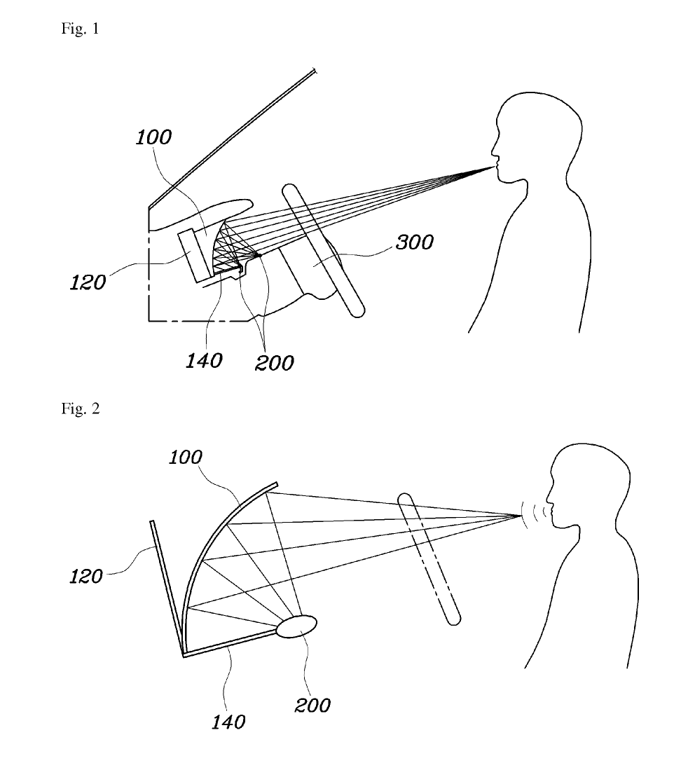

Referring to FIG. 1, the driver voice sound receiving device includes a cluster lens 100 having a transparent radial curved panel that is configured to protect a cluster dashboard in front of a driver's seat, reflect sound waves generated by a driver's voice and collect the reflected voice sound waves at a specific location in front of the cluster lens. The driver voice sound receiving device also includes a microphone 200 arranged adjacent to the specific location where the voice sound waves reflected by the cluster lens are collected.

In more detail, a cluster lens 100 is provided generally on a cluster provided in front of a driver's seat to protect a cluster dashboard 120. Further, the cluster lens is designed as concave curved surface in the direction of an instrument cluster so that sound waves can be efficiently and accurately collected in the cluster dashboard 120. Notably, it is preferable that other images around the cluster lens 100 are not formed thereon.

The cluster dashboard 120 is protected, visibility is ensured, and sound waves from a driver voice are reflected toward a specific location in front of the driver to be collected by the microphone 200 by using the cluster lens 100 as a reflected surface. More specifically, the microphone 200 is provided in a specific location so that the reflected voice sound waves are collected by the microphone to increase voice sound recognizing rate while the driver is looking straight ahead as can be seen in FIGS. 1-2.

As shown in FIG. 1, a driver generally is positioned so that his/her eyes are forward facing while driving, and when sound waves are produced by the driver, the sound waves are transmitted toward the cluster lens 100 provided in front of the driver. Accordingly, in the illustrative embodiment of the present invention, the microphone 200 may be provided in front of the driver to receive efficiently the driver's sound wave generated by his or her voice. This is accomplished by reflecting the sound waves from the cluster lens and into a specific location between the driver and the cluster lens 100 and placing a microphone either at or adjacent to this location to receive high quality sound waves.

Furthermore, FIG. 2 is a view illustrating exemplary sounds waves from a driver's voice that are collected at a specific location by the driver voice sound receiving device as shown in FIG. 1. In particular, the cluster lens 100 may be shaped as a dish type antenna so that it is curved concavely toward the cluster dashboard 120 so that sound waves from the driver's voice are reflected and collected toward front and lower sides of the cluster lens 100 (i.e., at a location between the cluster lens and the driver).

By shaping the cluster lens in a dish type antenna configuration the amount of sounds waves that are collected by the device is increased and antennas a result the degree of accuracy of the resulting sound recorded by the device increases as well. As shown in FIG. 2, the sound waves from a driver's voice are diffused as they reach the cluster lens 100. However, due to the shape of the cluster lens 100, the sound waves reflected back to a common specific location by the cluster lens so that the microphone 200 installed at or around this location may easily receive an increased number of sound waves. That is, the microphone 200 may be provided in a location where the sound waves from the driver's voice are collected to greatly increase the voice recognition rate of the device.

As shown in FIG. 1, the microphone 200 may be provided on an upper face of a steering wheel column facing a front surface of the cluster lens 100. Alternatively, the microphone 200 may be provided on a lower side of the cluster lens 100. That is, on a cluster base panel on which the cluster dashboard 120 is arranged. However, the microphone 200 may be provided at any location between a rear side of a steering wheel and a front surface the cluster base panel 140 since the specific place where the waves of a driver voice sound are collected varies depending on a location of a vehicle seat and a cluster design.

That is, typically there is no obstacle in the a vehicle which will interrupt a sound waves produced from a driver between the rear side of the steering wheel and the cluster base panel 140, and since the specific place where the wave is collected can be varied by designing the cluster lens 100 via adjusting a curvature of curved surface thereof, the microphone may be provided in a number of locations to increase the driver voice recognition rate.

The microphone 200 is thus preferably provided between the steering wheel column and the cluster base panel 140 where the microphone 200 can most easily and readily receive sound waves transmitted by a driver.

Meanwhile, the microphone 200 may be as the same color as the cluster base panel 140. Generally, the cluster base panel 140 is black so that other images may be projected on the cluster lens 100 due to an external light and further the cluster lens 100 may be curved to project only the cluster base panel 140. That is, the color of the microphone 200 may be that same as the cluster base panel 140 to make the microphone indiscernible to the passengers and driver and further so that the microphone 200 is not projected onto the cluster lens 100.

Accordingly, the driver voice sound receiving device is configured such that the cluster base plate 140 formed with a flat plate is only provided on a lower side of the cluster lens 100 that is curved concavely toward the cluster dashboard 120 and the microphone 200 is provided adjacent to the specific location where sound waves from a driver's voice sound are collected to ensure visibility with respect to the cluster and provide a high quality sound which is collected by the microphone to thereby increase the voice recognition rate of the device. Furthermore, the microphone may be the same color as the cluster base panel (e.g., black) to prevent the microphone from being easily discernable to the driver.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. A driver voice sound receiving device, comprising:
a cluster lens in front of a driver's seat having transparent radial curved panel that is configured to protect a cluster dashboard and configured to reflect sound waves from a driver's voice to be collected at a specific location; and
a microphone provided adjacent the specific location where the voice sound waves reflected by the cluster lens are collected to collect the sound waves.

2. The driver voice sound receiving device of claim 1, wherein the cluster lens is shaped as a dish type antenna in which the cluster lens is curved concavely toward the cluster dashboard so that the driver voice sound waves are reflected to a specific front and lower side of the cluster lens to be collected by the microphone.

3. The driver voice sound receiving device of claim 1, wherein the microphone is provided on an upper face of a steering wheel column facing to a front surface of the cluster lens.

4. The driver voice sound receiving device of claim 1, wherein the microphone is provided on a cluster base panel on which the cluster dash board that is provided on a lower side of the cluster lens is arranged.

5. The driver voice sound receiving device of claim 1, wherein the microphone is as a same color as the cluster base panel.

6. A system, comprising:
a cluster lens in front of a driver's seat having transparent radial curved panel that is configured to protect a cluster dashboard and configured to reflect sound waves from a driver's voice to be collected at a specific location; and
a microphone provided adjacent the specific location where the voice sound waves reflected by the cluster lens are collected to collect the sound waves.

7. The system of claim 6, wherein the cluster lens is shaped as a dish type antenna in which the cluster lens is curved concavely toward the cluster dashboard so that the driver voice sound waves are reflected to a specific front and lower side of the cluster lens to be collected by the microphone.

8. The system of claim 6, wherein the microphone is provided on an upper face of a steering wheel column facing to a front surface of the cluster lens.

9. The system of claim 6, wherein the microphone is provided on a cluster base panel on which the cluster dash board that is provided on a lower side of the cluster lens is arranged.

10. The system of claim 6, wherein the microphone is as a same color as the cluster base panel.
